(19) United States
(12) Patent Application Publication
(10) Pub. No.: US 2021/0005852 A1
(43) Pub. Date: Jan. 7, 2021

(54) HIGH-ENERGY-DENSITY DEFORMABLE BATTERIES

(71) Applicant: THE TRUSTEES OF COLUMBIA UNIVERSITY IN THE CITY OF NEW YORK, New York, NY (US)

(72) Inventors: Yuan YANG, New York, NY (US); Guoyu QIAN, Wuhan (CN); Xi CHEN, New York, NY (US); Xiangbiao LIAO, New York, NY (US); Changmin SHI, College Park, MD (US); Tianyang WANG, Columbus, OH (US)

(73) Assignee: THE TRUSTEES OF COLUMBIA UNIVERSITY IN THE CITY OF NEW YORK, New York, NY (US)

(21) Appl. No.: 16/979,312

(22) PCT Filed: Mar. 11, 2019
(86) PCT No.: PCT/US2019/021633

§ 371 Date: Sep. 9, 2020

Related U.S. Application Data
(60) Provisional application No. 62/773,673, filed on Nov. 30, 2018.
(60) Provisional application No. 62/772,432, filed on Nov. 28, 2018.
(60) Provisional application No. 62/772,422, filed on Nov. 28, 2018.
(60) Provisional application No. 62/770,395, filed on Nov. 21, 2018.
(60) Provisional application No. 62/640,770, filed on Mar. 9, 2018.

(51) Int. Cl. H01M 2/02; H01M 4/587; H01M 4/38; H01M 4/66; H01M 2/16; H01M 2/20; H01M 10/052; H01M 10/058

(52) U.S. Cl. CPC H01M 2/0275; H01M 4/587; H01M 4/382; H01M 4/661; H01M 2/1653; H01M 2220/30; H01M 2/204; H01M 10/052; H01M 10/058; H01M 2/026; H01M 2/0285

(57) ABSTRACT

An energy storage device is disclosed that includes an axial structure with two or more rigid energy storage units and conductive flexible components separating adjacent rigid energy storage units. The rigid energy storage units include a plurality of folded layers, including an anode layer, a cathode layer, a first current collector layer, a second current collector layer, one or more separator layers, and one or more tape layers. The adjacent rigid energy storage units are produced by folding the plurality of layers one or more times onto themselves at a plurality of locations along the axial structure. The axial structure is then sealed in an aluminized casing along with an electrolyte material. The energy storage device exhibits high energy density, high foldability, and excellent electrochemical performances by virtue of the folded rigid energy storage segments connected by the flexible components. The conductive flexible component functions in a similar way as the soft marrow between vertebrae in the spine, providing excellent overall flexibility.

### CROSS REFERENCE TO RELATED APPLICATION(S)

This application is a national stage patent filing of International Patent Application No. PCT/US2019/021633, filed Mar. 11, 2019, which claims the benefit of U.S. Provisional Application Nos. 62/640,770, filed Mar. 9, 2018; 62/770,395, filed Nov. 21, 2018; 62/772,422, filed Nov. 28, 2018; 62/772,432, filed Nov. 28, 2018; and 62/773,673, filed Nov. 30, 2018, which are incorporated by reference as if disclosed herein in their entireties.

### STATEMENT REGARDING FEDERALLY SPONSORED RESEARCH OR DEVELOPMENT

This invention was made with government support under 1420634 awarded by National Science Foundation. The Government has certain rights in the invention.

### BACKGROUND

In recent years, the rapid development of wearable electronics such as smart watches has increased demand for high-performance, seamlessly compatible flexible batteries. They can be used in almost every aspect of life, such as health care, military, displays, and so on. Current designs of flexible batteries are ill equipped to handle harsh yet common deformation-folding while still maintaining high energy density and cost-effective fabrication found with commercial batteries.

Further, high-performance stretchable batteries are key components for stretchable devices. However, it is challenging to have both high stretchability and high energy density simultaneously. Stretchability is highly attractive for health care, sensing, displays, and wearable devices since stretchable devices can be conformably applied to human body and other surfaces with arbitrary shape. Stretchable batteries are highly desired as they can be seamlessly integrated with other stretchable components and provide steady power.

Lithium-ion batteries (LIBs) are attractive for use in powering electronic devices due to their high energy density, but realizing LIBs with sufficient flexibility that can simultaneously maintain a high energy density remains a significant challenge. In recent years, extensive efforts have been devoted into developing stretchable LIBs. PDMS and other stretchable polymers-based devices have been demonstrated, but they suffer from low energy density. Buckled carbon structures, e.g., carbon nanofibers, carbon nanotubes, have also shown stretchability, but corresponding energy densities are still not satisfactory.

### SUMMARY

Some embodiments of the present disclosure are directed to a deformable energy storage device that still provides steady power comparable to commercial batteries, even during deformation. In some embodiments, the energy storage device includes an axial structure including two or more rigid energy storage units. In some embodiments, the rigid energy storage units include a plurality of folded layers. In some embodiments, the plurality of folded layers include an anode layer, a cathode layer, a first current collector layer, a second current collector layer, and one or more separator layers. In some embodiments, the energy storage device includes a casing enclosing the two or more rigid energy storage units and an electrolyte material within the casing. In some embodiments, the casing includes an aluminized bag.

In some embodiments, the one or more separator layers includes polyethylene, polypropylene, or combinations thereof. In some embodiments, the anode layer includes graphite. In some embodiments, the first current collector layer is disposed over the anode layer. In some embodiments, the first current collector layer includes copper. In some embodiments, a first separator layer is disposed between the anode layer and the cathode layer. In some embodiments, the second current collector layer is disposed between the cathode layer and a second separator layer. In some embodiments, the second current collector layer includes aluminum. In some embodiments, the cathode layer includes lithium.

In some embodiments, the energy storage device includes a conductive flexible component separating adjacent rigid energy storage units. In some embodiments, the conductive flexible component includes a tape layer. In some embodiments, the conductive flexible component includes a metallic layer disposed between two tape layers.

In some embodiments, the energy storage device includes an axial backbone, and the plurality of folded layers are wrapped around the backbone at least once. In some embodiments, the two or more rigid energy storage units include a plurality of layers folded onto each other, such that the energy storage device adopts a generally zigzag configuration. In some embodiments, the conductive flexible component includes one or more folds, enabling the conductive flexible component to stretch from a first length to a second length. In some embodiments, the energy storage device is configured such that L/a is between 0.30 and 1.0, wherein L is the length of the conducive flexible component and a is the energy storage length of rigid energy storage units adjacent the conductive flexible component.

Some embodiments of the present disclosure are directed to a method of making an energy storage device. In some embodiments, the method includes forming an axial structure including a plurality of layers. In some embodiments, the method includes folding the plurality of layers one or more times onto themselves at a first location to produce a rigid energy storage unit and an adjacent conductive flexible component. In some embodiments, the method includes folding the layers one or more times onto themselves at additional locations to produce additional rigid energy storage units with adjacent flexible components. In some embodiments, the method includes sealing the axial structure in an aluminized casing.

Some embodiments of the present disclosure are directed to a method of making an energy storage device. In some embodiments, the method includes providing an axial structure including a first electrode layer and a second electrode layer. In some embodiments, the method includes cutting the axial structure to create a plurality of branches extending from an axial backbone. In some embodiments, the method includes wrapping the plurality of branches around the axial backbone to provide two or more rigid energy storage units and conductive flexible components separating the adjacent rigid energy storage units. In some embodiments, the method includes laminating the axial backbone at the conductive stretchable component with a tape layer. In some embodiments, the method includes sealing the axial structure in an aluminized casing including an electrolyte material.

### BRIEF DESCRIPTION OF THE DRAWINGS

The drawings show embodiments of the disclosed subject matter for the purpose of illustrating the invention. However, it should be understood that the present application is not limited to the precise arrangements and instrumentalities shown in the drawings, wherein:

FIG. 1A is a schematic representation of a high-energy-density deformable battery according to some embodiments of the present disclosure;

FIG. 1B is a schematic representation of a high-energy-density deformable battery according to some embodiments of the present disclosure;

FIG. 1C is a schematic representation of a high-energy-density deformable battery according to some embodiments of the present disclosure;

FIG. 2A is a schematic representation of a high-energy-density deformable battery according to some embodiments of the present disclosure;

FIG. 2B is a schematic representation of a high-energy-density deformable battery according to some embodiments of the present disclosure;

FIG. 2C is a schematic representation of a high-energy-density deformable battery according to some embodiments of the present disclosure;

FIG. 2D is a schematic representation of a high-energy-density deformable battery according to some embodiments of the present disclosure;

FIG. 3 is a schematic representation of a high-energy-density deformable battery according to some embodiments of the present disclosure;

FIG. 4 is a chart of a method for making high-energy-density deformable batteries according to some embodiments of the present disclosure;

FIG. 5 is a chart of a method for making high-energy-density deformable batteries according to some embodiments of the present disclosure; and

FIG. 5 is an image of a high-energy-density deformable battery under deformation according to some embodiments of the present disclosure.

### DETAILED DESCRIPTION

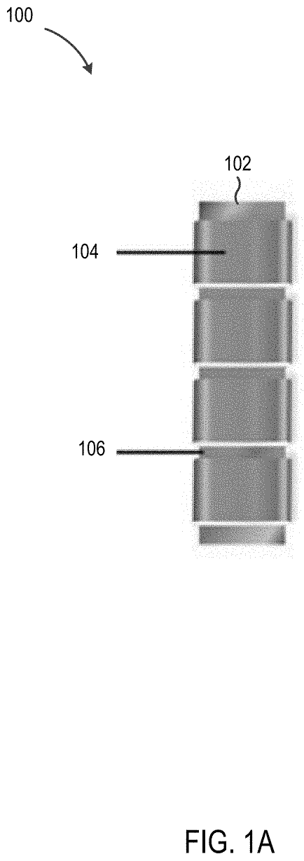

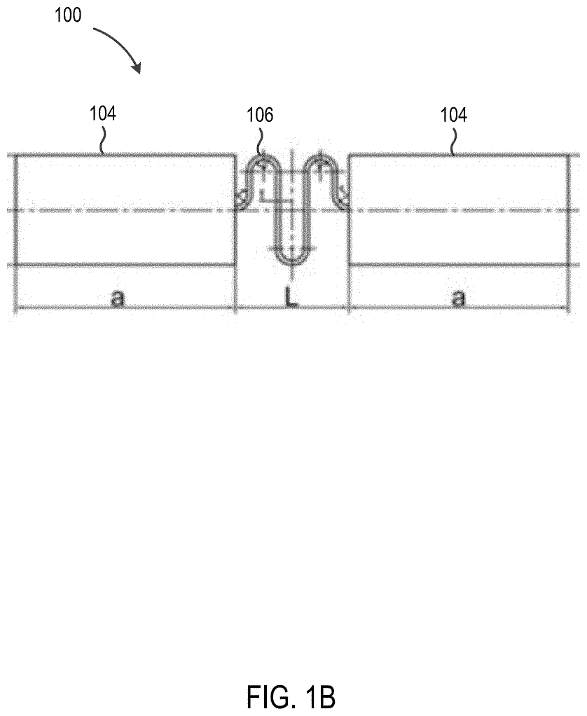

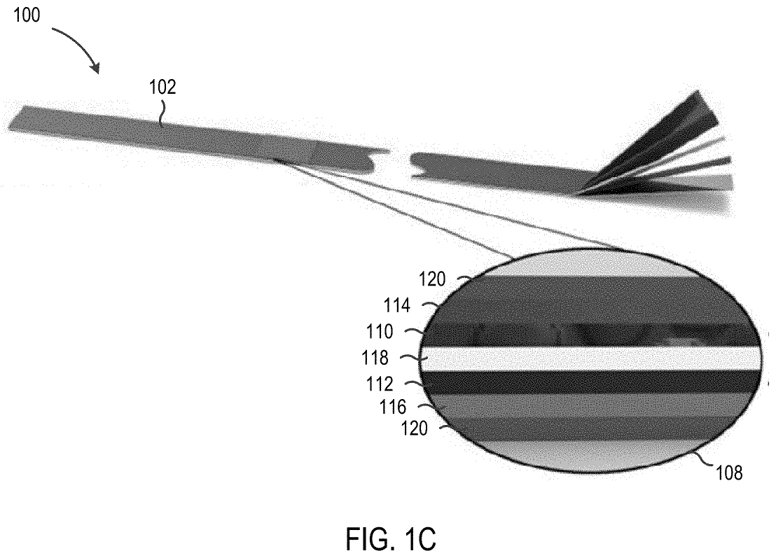

Referring now to FIG. 1A, some aspects of the disclosed subject matter include an energy storage device 100 including an axial structure 102. In some embodiments, energy storage 100 includes two or more rigid energy storage units 104 arranged along axial structure 102. In some embodiments, energy storage 100 includes a plurality of energy storage units 104. In some embodiments, a conductive flexible component 106 separates adjacent rigid energy storage units 104. Referring now to FIG. 1B, in some embodiments, energy storage device 100 is configured such that L/a is between 0.30 and 1.0, wherein L is the length of conducive flexible component 106 and a is the energy storage length of rigid energy storage units 104 adjacent the conductive flexible component.

Referring now to FIG. 1C, in some embodiments, axial structure 102 includes a plurality of layers 108. In some embodiments, the plurality of layers includes an anode layer 110, a cathode layer 112, a first current collector layer 114, a second current collector layer 116, one or more separator layers 118, one or more tape layers 120, or combinations thereof. In some embodiments, the anode layer 110 includes graphite. In some embodiments, the first current collector layer 114 is disposed over the anode layer 110. In some embodiments, the first current collector layer 114 includes copper. In some embodiments, a first separator layer 118A is disposed between the anode layer 110 and the cathode layer 112. In some embodiments, cathode layer 112 includes lithium. In some embodiments, cathode layer 112 is composed of lithium metal, a lithium compound or a chemically similar material or combinations thereof. In some embodiments, cathode layer 112 is composed of LiCoO₂, Li(NiₓCo_{y}Mn_{z})O₂, LiFePO₄, Li₄Ti₅O₁₂, or combinations thereof. In some embodiments, the one or more separator layers 118 include polyethylene, polypropylene, or combinations thereof. In some embodiments, the second current collector layer 116 is disposed on cathode layer 112. In some embodiments, second current collector layer 116 is disposed between cathode layer 112 and a second separator layer 118B. In some embodiments, second current collector layer 116 includes aluminum. In some embodiments, the conductive flexible component 106 includes a metallic layer disposed between a plurality of tape layers 120. In some embodiments, the conductive flexible component 106 includes a metallic layer disposed between two tape layers 120.

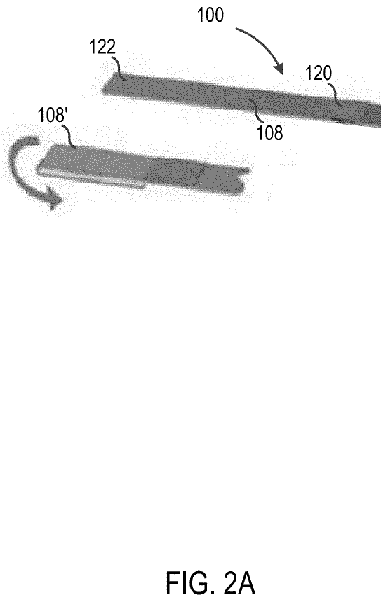

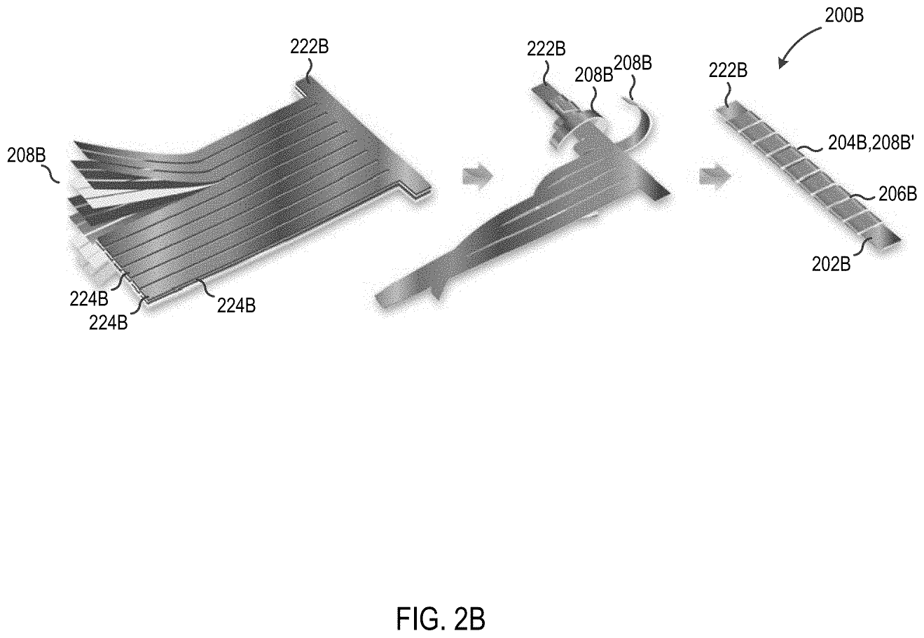

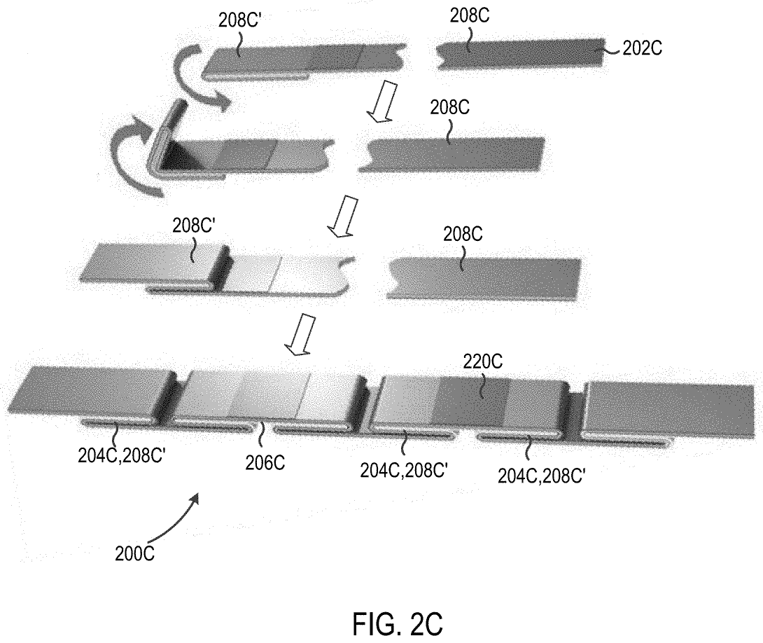

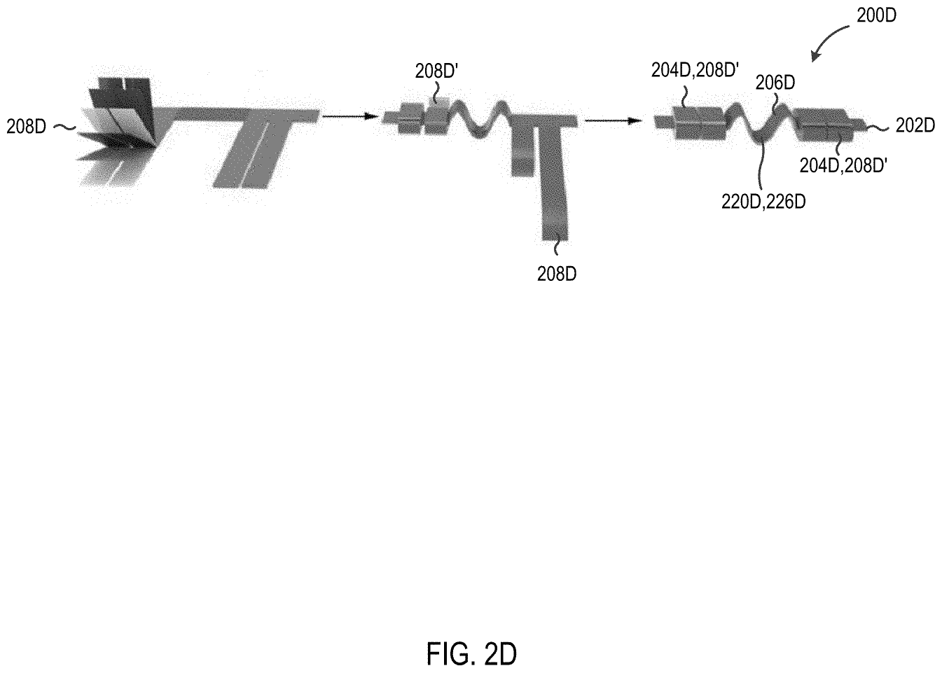

Referring now to FIGS. 2A-2D, in some embodiments, at least some of layers 108 are folded into a stack to define rigid energy storage units 104. In these embodiments, rigid energy storage units 104 include a plurality of folded layers 108′. In some embodiments, plurality of folded layers 108′ are folded versions of layers 108. In some embodiments, plurality of folded layers 108′ are layers 108 folded onto themselves. In some embodiments, energy storage device 100 includes an axial backbone 122. In some embodiments, axial backbone 122 includes layers 108, layers 108′, or combinations thereof. In some embodiments, plurality of folded layers 108′ are wrapped around axial backbone 122, which will be discussed in greater detail below.

Referring now specifically to FIG. 2B, in some embodiments, energy storage device 200B includes an axial structure 202B. Energy storage device 200B includes a plurality of rigid energy storage units 204B. Rigid energy storage units 204B are composed of a plurality of folded layers 208B′ that are folded, e.g., by wrapping layers 208B around an axial backbone 222B at least once. Rigid energy storage units 204B can be of any suitable shape, e.g., ovular, circular, polyhedral, zigzag, etc., or combinations thereof. In some embodiments, the plurality of layers 208B are provided in a comb-shaped structure having one or more teeth portions 224B extending from axial backbone 222B. In some embodiments, plurality of layers 208B are first stacked so as to align the axial backbones 222B of adjacent layers. Teeth portions 224B are then wrapped around axial backbones 222B to define the rigid energy storage units 204B. In some embodiments, a conductive flexible component 206B is disposed between adjacent rigid energy storage units 204B. In some embodiments, conductive flexible component 206B includes a metallic layer disposed between a plurality of tape layers.

Referring now specifically to FIG. 2C, in some embodiments, energy storage device 200C includes an axial structure 202C. Energy storage device 200C includes a plurality of rigid energy storage units 204C. Rigid energy storage units 204C are composed of a plurality of folded layers 208C′ that are folded onto each other. In some embodiments, the plurality of layers 208C are folded onto each other such that energy storage device 200C adopts a generally zigzag configuration. In some embodiments, a conductive flexible component 206C is disposed between adjacent rigid energy storage units 204C. In some embodiments, conductive flexible component 206C includes a metallic layer disposed between one or more tape layers 220C.

Referring now to FIG. 2D, in some embodiments, energy storage device 200D includes an axial structure 202D. Energy storage device 200D includes at least two rigid energy storage units 204D. As discussed above, rigid energy storage units 202D are composed of a plurality of folded layers 208D′, assembled, e.g., according to the various embodiments discussed elsewhere in the present disclosure. Rigid energy storage units 204D can be of any suitable shape, e.g., ovular, circular, polyhedral, zigzag, etc., or combinations thereof. In some embodiments, a conductive flexible component 206D is disposed between adjacent rigid energy storage units 204D. In some embodiments, conductive flexible component 206D includes a metallic layer disposed between a plurality of tape layers 220D. In some embodiments, conductive flexible component 206D includes one or more folds 226D, enabling the conductive flexible component to stretch from a first length to a second length.

Without wishing to be bound by theory, the stretchability of energy storage device 100 depends on the relative dimension of conductive flexible component 106 (stretching length, L) to energy storage units 104 (energy storage length, a). In pressed state:

L=2Nr+2r

where N is the number of periods, and r is the bending radius. The minimum value of N is 1.

In stretched state, conductive flexible component 206D length L is replaced by l.

l=πr(N+1)+N(h−4r)+2r(N−1)

Stretchability can be defined as:

$$\frac{100 ( l - L )}{a + L}$$

Relative energy density can be defined as:

$$\frac{100 a}{a + L}$$

Max strain:

$$ɛ = \frac{t}{2 r}$$

where t is the thickness of conductive flexible component 106 with tape layers 120. In some exemplary embodiments, t=0.270 mm. When r equals to 0.75 mm, ε=18.0%, and if r equals to 1 mm, ε=13.5%

By way of example, it is assumed that r can be either 0.75 mm or 1 mm, α is 10 mm, and h is 5 mm. Then N as an integer is varied. With the design shown in FIG. 2D, given the bending radius r equals 0.75 mm, and when the ratio of L/a is 0.30, the stretchability can reach about 29%, and the corresponding energy density is about 77% of a battery by conventional packaging.

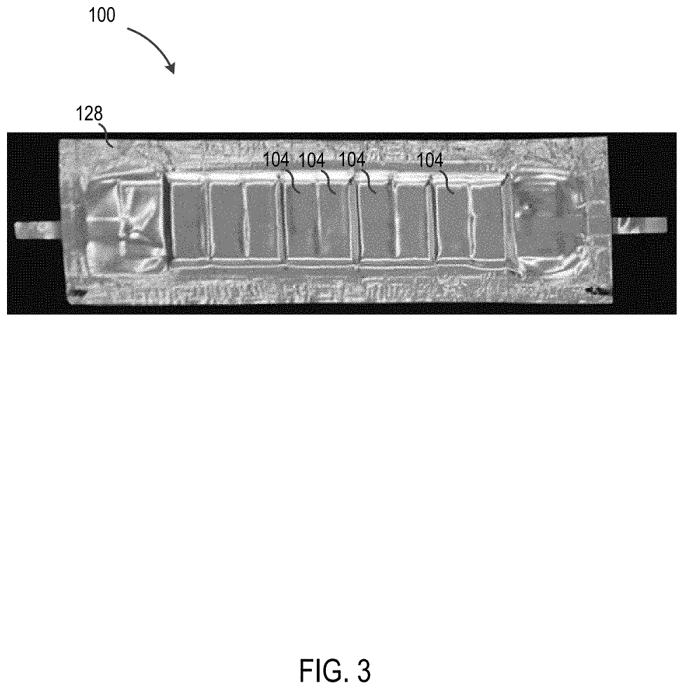

Referring now to FIG. 3, energy storage device 100 includes a casing 128 enclosing the two or more rigid energy storage units 104. In some embodiments, casing 124 includes an electrolyte material, e.g., LiPF₆ in ethylene carbonate/diethyl carbonate (1:1 vol/vol). In some embodiments, casing 124 includes a bag. In some embodiments, the bag includes an aluminum layer.

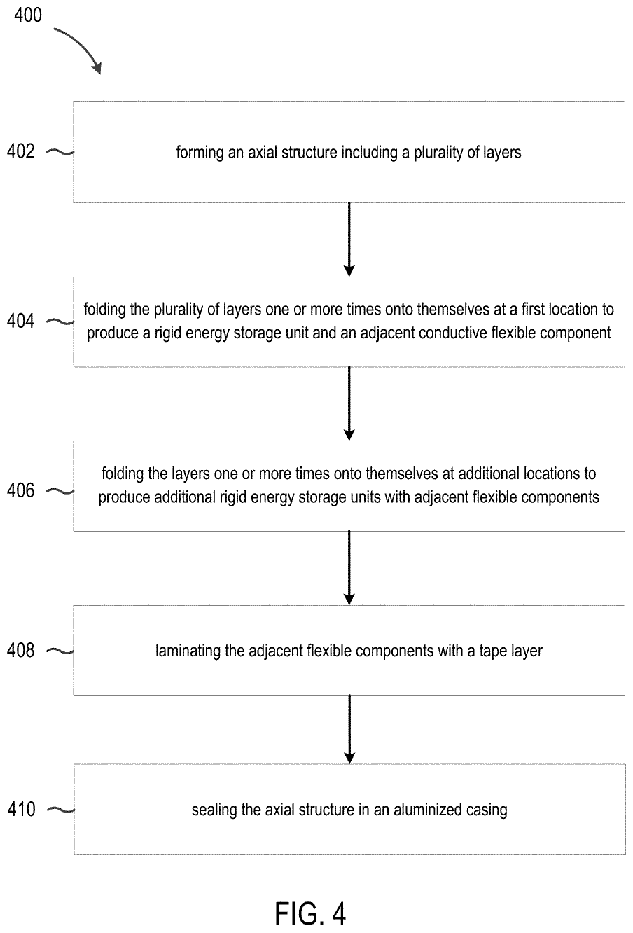

Referring now to FIG. 4, some aspects of the present disclosure include a method 400 of making an energy storage device. At 402, an axial structure including a plurality of layers is formed. At 404, the plurality of layers are folded onto themselves one or more times at a first location, producing a rigid energy storage unit at the first location. At 406, the plurality of layers are folded one or more times onto themselves at additional locations to produce additional rigid energy storage units at additional locations. In some embodiments, folding the layers one or more times onto themselves at additional locations produces additional rigid energy storage units with adjacent flexible components in a zigzag-like configuration. As discussed above, in some embodiments, conductive flexible components are adjacent to the rigid energy storage unit and connect adjacent rigid energy storage units. In some embodiments, at 408, the adjacent flexible components are laminated with a tape layer. In some embodiments, the conductive flexible components include a metallic layer disposed between a plurality, e.g., at least two, tape layers. At 410, the axial structure is sealed in a casing, e.g., an aluminized bag.

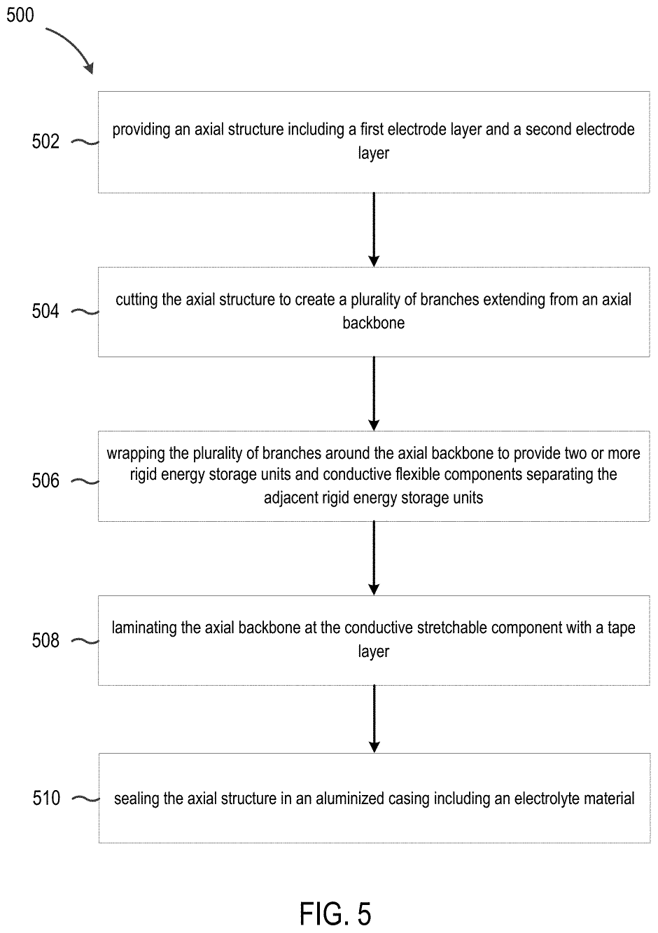

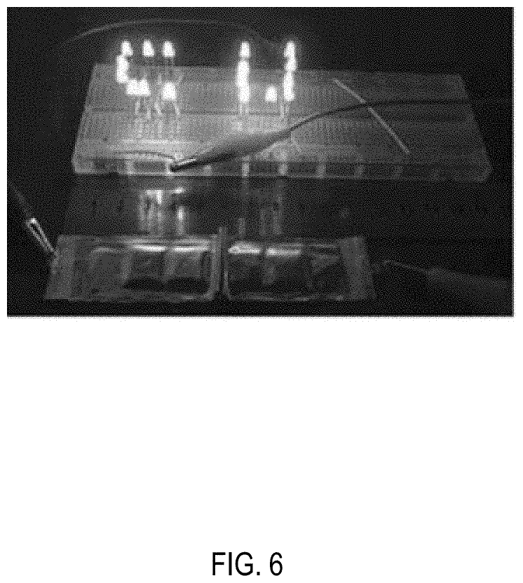

Referring now to FIG. 5, in some embodiments, method 500 includes, at 502, providing an axial structure including a first electrode layer and a second electrode layer. As discussed above, in some embodiments, the first electrode layer is an anode layer including graphite and the second electrode layer is a cathode layer including lithium. At 504, the axial structure was cut to create a plurality of branches extending from an axial backbone. At 506, the plurality of branches were wrapped around the axial backbone to provide two or more rigid energy storage units and conductive flexible components separating the adjacent rigid energy storage units. At 508, the axial backbone is laminated at the conductive stretchable component with a tape layer. At 510, the axial structure was sealed in an aluminized casing including an electrolyte material.

Methods and systems of the present disclosure are advantageous in that they exhibit high energy density (275 Wh/L, that is 96.4% of its conventional counterpart), high foldability, and excellent electrochemical performances by virtue of the folded rigid energy storage segments connected by the conductive flexible components. The conductive flexible component functions in a similar way as the soft marrow between vertebrae in the spine, providing excellent flexibility for the whole device. A stable cycling of over many cycles with initial discharge capacity of 151 mA h g⁻¹ and retention of 94.3% can be achieved, even with various kinds of mechanical deformation applied.

The foldable batteries with controllable geometrics are easily fashioned to be compatible with different devices. Further, all materials used in the fabrication of these batteries have been demonstrated not to be costly. Finally, the device also survives a continuous dynamic mechanical load test and thus has been proven to be much more mechanically robust compared to conventional battery designs. Referring now to FIG. 6, the foldable batteries according to some embodiments of the present disclosure have been shown to power 17 LEDs, and even with continuous mechanical deformation during lighting, the brightness of LEDs keeps stable. The batteries also perform very well even in large current density (ranging from 0.5 C to 3 C).

Systems of the present disclosure are also advantageous in that they decouple the stretchable component and the energy storage component. Thus, high energy density and high stretchability can be achieved simultaneously. In some embodiments, the tape is only applied to the conductive flexible component, and thus does not lead to redundant volume in the energy storage units, and has little effect on the volumetric energy density.

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed is:

1. An energy storage device comprising:
an axial structure including two or more rigid energy storage units including a plurality of folded layers; and
a conductive flexible component separating adjacent rigid energy storage units.

2. The device according to claim 1, wherein the plurality of folded layers include an anode layer, a cathode layer, a first current collector layer, a second current collector layer, and one or more separator layers.

3. The device according to claim 2, wherein:
the anode layer includes graphite;
the first current collector layer is disposed over the anode layer, the first current collector layer including copper;
a first separator layer is disposed between the anode layer and the cathode layer;
the second current collector layer is disposed between the cathode layer and a second separator layer, wherein the second current collector layer includes aluminum; and
the cathode layer includes lithium.

4. The device according to claim 2, wherein the one or more separator layers includes polyethylene, polypropylene, or combinations thereof.

5. The device according to claim 1, further comprising a casing enclosing the two or more rigid energy storage units, and an electrolyte material within the casing.

6. The device according to claim 5, wherein the casing includes an aluminized bag.

7. The device according to claim 1, wherein the device includes an axial backbone, and the plurality of folded layers are wrapped around the backbone at least once.

8. The device according to claim 1, wherein the two or more rigid energy storage units include a plurality of layers folded onto each other, such that the energy storage device adopts a generally zigzag configuration.

9. The device according to claim 1, wherein the conductive flexible component includes one or more folds, enabling the conductive flexible component to stretch from a first length to a second length.

10. The device according to claim 9, wherein the device is configured such that L/a is between 0.30 and 1.0, wherein L is the length of the conducive flexible component and a is the energy storage length of rigid energy storage units adjacent the conductive flexible component.

11. The device according to claim 1, wherein the conductive flexible component includes a tape layer.

12. The device according to claim 11, wherein the conductive flexible component includes a metallic layer disposed between two tape layers.

13. A method of making an energy storage device comprising:
forming an axial structure including a plurality of layers;
folding the plurality of layers one or more times onto themselves at a first location to produce a rigid energy storage unit and an adjacent conductive flexible component;
folding the layers one or more times onto themselves at additional locations to produce additional rigid energy storage units with adjacent flexible components; and
sealing the axial structure in an aluminized casing.

14. The method according to claim 13, wherein forming the axial structure including the plurality of layers includes:
cutting the plurality of layers to create a plurality of branches extending from an axial backbone.

15. The method according to claim 13, further comprising:
laminating the adjacent flexible components with a tape layer.

16. The method according to claim 15, wherein folding the layers one or more times onto themselves at additional locations produces additional rigid energy storage units with adjacent flexible components in a zigzag-like configuration.

17. The method according to claim 13, wherein:
the anode layer includes graphite;
the first current collector layer is disposed over the anode layer, the first current collector layer including copper;
a first separator layer is disposed between the anode layer and the cathode layer;
the second current collector layer is disposed between the cathode layer and a second separator layer, wherein the second current collector layer includes aluminum; and
the cathode layer includes lithium.

18. The device according to claim 13, wherein the device is configured such that L/a is between 0.30 and 1.0, wherein L is the length of the conducive flexible component and a is the energy storage length of rigid energy storage units adjacent the conductive flexible component.

19. A method of making an energy storage device comprising:
providing an axial structure including a first electrode layer and a second electrode layer;
cutting the axial structure to create a plurality of branches extending from an axial backbone;
wrapping the plurality of branches around the axial backbone to provide two or more rigid energy storage units and conductive flexible components separating the adjacent rigid energy storage units;
laminating the axial backbone at the conductive stretchable component with a tape layer; and
sealing the axial structure in an aluminized casing including an electrolyte material.

20. The method according to claim 19, wherein
the first electrode layer is an anode layer including graphite and the second electrode layer is a cathode layer including lithium; and
wherein the axial structure includes:
a first current collector layer disposed over the anode layer, the first current collector layer including copper;
a first separator layer disposed between the anode layer and the cathode layer; and
a second current collector layer is disposed between the cathode layer and a second separator layer, wherein the second current collector layer includes aluminum.
